(19) United States
(12) Patent Application Publication
(10) Pub. No.: US 2009/0098315 A1
(43) Pub. Date: Apr. 16, 2009

(54) Photoreactive adhesive composition and liquid crystal panel prepared by using the same

(76) Inventor: Masanori Matsuda, Koka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/907,504

(22) Filed: Oct. 12, 2007

(51) Int. Cl. C09K 19/00; C08L 33/10; C08J 3/28

(52) U.S. Cl. 428/1.33; 522/153

(57) ABSTRACT

The photoreactive adhesive composition of the present invention is cured in a short time and has a low percentage of water absorption and excellent adhesiveness after curing because it contains a monofunctional radically-polymerizable substance, a polyfunctional cationically-polymerizable substance, a noncrystalline polyester resin, a photoradical polymerization initiator, and a photocationic polymerization initiator.

### FIELD OF THE INVENTION

The present invention relates to a photoreactive adhesive composition containing a monofunctional radically-polymerizable substance and a polyfunctional cationically-polymerizable substance, and to a liquid crystal panel prepared by using the photoreactive adhesive composition. In particular, it relates to a photoreactive adhesive composition which cures through polymerization of a monofunctional radically-polymerizable substance and a polyfunctional cationically-polymerizable substance due to irradiation with light, and to a liquid crystal panel prepared by using the photoreactive adhesive composition.

### BACKGROUND OF THE INVENTION

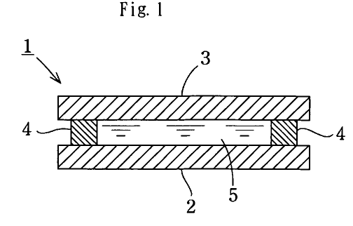

As shown in FIG. 1, a liquid crystal panel 1, which is used for liquid crystal display devices such as liquid crystal displays and liquid crystal television receivers, is obtained for example by joining two substrates 2, 3, each having an electroconductive film of indium tin oxide (hereinafter, “ITO”) (not shown), at a certain distance with a sealing material 4 in a frame shape while leaving a liquid crystal injection inlet (not shown) uncovered; injecting a liquid crystal 5 through the liquid crystal injection inlet into a liquid crystal filling space formed between the sealing material 4 and the substrates 2, 3; and sealing the liquid crystal injection inlet.

As such a sealing material, many photoreactive adhesives containing a radically-polymerizable polyfunctional resin are in use.

Some conventional photoreactive adhesives containing a polyfunctional resin are poor in adhesiveness due to a high shrinkage percentage exhibited at the time of curing. When the shrinkage percentage at the time of curing is reduced by incorporating a nonreactive adhesion imparter or the like in order to improve the adhesiveness of a photoreactive adhesive, the crosslink density tends to decrease and as a result the percentage of water absorption tends to become high. If the percentage of water absorption of a photoreactive adhesive is high, use of the photoreactive adhesive for sealing a liquid crystal may result in pollution of the liquid crystal or the like.

In light of such circumstances, various attempts to control the decrease in the crosslink density and to improve the adhesiveness have been made in the photoreactive adhesive field.

JP 2003-107494 A discloses an adhesive which can be photoradically polymerized and which includes, as a base resin, an organic material having a functional group polymerizable with an auxiliary crosslinking agent. JP2003-107494 A teaches that the adhesive can be cured by irradiation with light in a short time and it can be cured certainly by heat.

JP 2003-107494 A reports that it is possible to cure an adhesive by using a base resin such as an epoxy resin or an epoxy acrylate resin, and an auxiliary crosslinking agent which can react with the base resin.

However, in JP2003-107494 A, the curing requires along time because the curing is caused by heat. Therefore, use of such an adhesive for sealing a liquid crystal in a liquid crystal panel may result in poor production efficiency. Furthermore, heating at the time of curing may have some adverse effects on the liquid crystal or the like.

### SUMMARY OF THE INVENTION

The present invention provides a photoreactive adhesive composition which is capable of curing through polymerization of a monofunctional radically-polymerizable substance and a polyfunctional cationically-polymerizable substance due to irradiation with light and which is capable of showing a low percentage of water absorption and excellent adhering performance after curing.

The photoreactive adhesive composition of the present invention is characterized by containing a monofunctional radically-polymerizable substance, a polyfunctional cationically-polymerizable substance, a noncrystalline polyester resin, a photoradical polymerization initiator, and a photocationic polymerization initiator.

The photoreactive adhesive composition is characterized in that the monofunctional radically-polymerizable substance comprises a monofunctional (meth)acryl-based monomer and/or a monofunctional (meth)acryl-based oligomer.

The photoreactive adhesive composition is characterized in that it is capable of being cured by UV light with an intensity of from 500 to 5000 mJ/cm² and the cured product has an elastic modulus at 25° C. of from 1×10⁷ to 2×10⁹ Pa, a glass transition temperature of from 10 to 60° C., and a percentage of water absorption of from 0.5 to 2.5%.

Furthermore, the photoreactive adhesive composition is characterized by containing the polyfunctional cationically-polymerizable substance, the noncrystalline polyester resin, the photoradical polymerization initiator and the photocationic polymerization initiator in amounts of from 15 to 75 parts by weight, from 16.7 to 150 parts by weight, from 0.17 to 12.5 parts by weight, and from 0.17 to 12.5 parts by weight, respectively, per 100 parts by weight of the monofunctional radically-polymerizable substance.

The photoreactive adhesive composition is characterized in that the polyfunctional cationically-polymerizable substance is a polyfunctional glycidyl ether compound.

Further, the photoreactive adhesive composition is characterized in that the noncrystalline polyester resin has a glass transition temperature of 20° C. or lower and a number average molecular weight of from 5000 to 100000.

The liquid crystal panel of the present invention is characterized by comprising two base materials that are made of a synthetic resin film having an elastic modulus of from 490 to 2940 Pa and an elongation at break of from 50 to 500% and are arranged at a predetermined distance away from each other; a cured product that is prepared by curing a photoreactive adhesive composition comprising a monofunctional radically-polymerizable substance, a polyfunctional cationically-polymerizable substance, a noncrystalline polyester resin, a photoradical polymerization initiator and a photocationic polymerization initiator, the cured product being arranged in a frame shape on outer peripheral parts of facing surfaces of the base materials; and a liquid crystal filled in a liquid crystal filling space surrounded by the base materials and the cured product.

### BRIEF DESCRIPTION OF THE DRAWING

(FIG. 1) A front sectional view schematically showing one example of a liquid crystal panel.

### DETAILED DESCRIPTION OF THE PREFERRED EMBODIMENTS

The photoreactive adhesive composition of the present invention is characterized by containing a monofunctional radically-polymerizable substance, a polyfunctional cationically-polymerizable substance, a noncrystalline polyester resin, a photoradical polymerization initiator, and a photocationic polymerization initiator.

In the present invention used is a monofunctional radically-polymerizable substance for reducing the shrinkage percentage at the time of curing and developing excellent adhesiveness. That is, a monofunctional radically-polymerizable substance is used because when the radically-polymerizable substance is polyfunctional, the shrinkage percentage at the time of curing is high and the adhesiveness deteriorates.

The monofunctional radically-polymerizable substance is a substance capable of being polymerized by irradiation with light and examples thereof include monofunctional (meth)acryl-based monomers and monofunctional (meth)acryl-based oligomers. In order to achieve a higher curing speed, it preferably contains a monofunctional acryl-based monomer or a monofunctional acryl-based oligomer. Such monofunctional radically-polymerizable substances may be used singly or in combination of two or more kinds. It is noted that (meth)acryl means acryl or methacryl.

Examples of monofunctional (meth)acryl-based monomers include 2-hydroxy-3-phenoxypropyl acrylate, lauryl (meth)acrylate, 2-hydroxy-3-phenoxypropyl (meth)acrylate, 2-(meth)acryloyloxyethyl phthalate, and 2-(meth)acryloyloxyethyl acid phosphate.

Examples of monofunctional (meth)acryl-based oligomers include phenoxypolyethylene glycol acrylate.

As a radically-polymerizable substance, a polyfunctional radically-polymerizable substance may be contained besides a monofunctional radically-polymerizable substance. If the polyfunctional radically-polymerizable substance is present in a large amount, the photoreactive adhesive composition comes to have a high crosslink density, which may result in deterioration of the adhesiveness of the photoreactive adhesive composition. Therefore, the content of the polyfunctional radically-polymerizable substance in the radically-polymerizable substance is preferably less than 20% by weight.

Examples of the polyfunctional radically-polymerizable substance include polyfunctional (meth)acryl-based monomers and polyfunctional (meth)acryl-based oligomers.

Examples of the polyfunctional (meth)acryl-based monomers include 2-butyl 2-ethyl-1,3-propanediol di(meth)acrylate, 1,9-nonanediol di(meth)acrylate, dimethylol-tricyclodecane di(meth)acrylate, bisphenol A-ethyleneoxide adduct di(meth)acrylate, and trimethylolpropanetri(meth)acrylate.

Examples of the polyfunctional acryl-based oligomers include urethane acrylate and polyester acrylate.

The polyfunctional cationically-polymerizable substance is a substance cationically-polymerizable by light irradiation and examples thereof include polyfunctional substances such as epoxy compounds, vinyl ether compounds and oxetane compounds. In order to achieve a higher curing speed, it preferably contains a polyfunctional alicyclic epoxy compound or a polyfunctional glycidyl ether compound.

Examples of the epoxy compound include polyfunctional alicyclic epoxy compounds such as 2,4-epoxycyclohexylmethyl-3,4-epoxycyclohexane carboxylate, bis(3,4-epoxycyclohexylmethyl) adipate, 2-(3,4-epoxycyclohexyl-5,5-spiro-3,4-epoxy)cyclohexanone-meta-dioxane, and bis(2,3-epoxycyclopentyl)ether; and polyfunctional glycidyl ether compounds such as bisphenol A diglycidyl ether, trisphenolmethane triglycidyl ether, 1,4-butanediol diglycidyl ether, 1,6-hexanediol diglycidyl ether, glycerol triglycidyl ether, trimethylolpropane triglycidyl ether, and propyleneglycol diglycidyl ether. The polyfunctional alicyclic epoxy resin is in the market, for example, under the commercial name “EHPE-3150” from Daicel Chemical Industries, Ltd. Bisphenol A diglycidyl ether, which is a polyfunctional glycidyl ether compound, is in the market, for example, under the commercial name “ADEKA RESIN EP-4080” from Adeka Corporation.

Examples of the vinyl ether compound include triethylene glycol divinyl ether, tetraethylene glycol divinyl ether, trimethylolpropane trivinyl ether, cyclohexane-1,4-dimethylol divinyl ether, 1,4-butanediol divinyl ether, polyester divinyl ether, and polyurethane polyvinyl ether.

Examples of the oxetane compound include 1,4-bis[(3-ethyl-3-oxetanylmethoxy)methyl]benzene, 1,3-bis[(3-ethyl-3-oxetanylmethoxy)methyl]propane, ethylene glycol bis(3-ethyl-3-oxetanylmethyl)ether, trimethylolpropane tris(3-ethyl-3-oxetanylmethyl)ether, pentaerythritol tetrakis(3-ethyl-3-oxetanylmethyl)ether, dipentaerythritol hexakis(3-ethyl-3-oxetanylmethyl)ether, and ethyleneoxide-modified bisphenol A bis(3-ethyl-3-oxetanylmethyl)ether.

The content of the polyfunctional cationically-polymerizable substance in the photoreactive adhesive composition is preferably from 15 to 75 parts by weight, more preferably from 16.7 to 75 parts by weight per 100 parts by weight of the monofunctional radically-polymerizable substance. The reason for this is that if the amount of the polyfunctional cationically-polymerizable substance is less than 15 parts by weight, the percentage of water absorption after curing of the photoreactive adhesive composition may become high, and if the amount of the polyfunctional cationically-polymerizable substance is more than 75 parts by weight, the adhesiveness and the heat resistance property of the photoreactive adhesive composition may deteriorate.

The noncrystalline polyester resin preferably has a glass transition temperature (hereafter, referred to as “Tg”) of 20° C. or lower and a number average molecular weight of from 5000 to 100000. The reason for this is that if the glass transition temperature of the noncrystalline polyester resin is higher than 20° C., the adhesiveness of the photoreactive adhesive composition may deteriorate. The glass transition temperature of the noncrystalline polyester resin is more preferably from −20 to 20° C. because if the glass transition temperature is too low, the composition may mix with a liquid crystal easily to pollute it when being used as a sealing material of the liquid crystal. It is also because if the number average molecular weight of the photoreactive adhesive composition is larger than 100000, the viscosity of the photoreactive adhesive composition may become too high and if the number average molecular weight is less than 5000, the percentage of water absorption of a cured product of the photoreactive adhesive composition may become high.

Noncrystalline polyester resins having a glass transition temperature of 20° C. or lower and a number average molecular weight of from 5000 to 100000 are in the market, for example, under the commercial names “Vylon 500,” “Vylon 550,” and “Vylon 560,” from Toyobo Co., Ltd.

The glass transition temperature of a noncrystalline polyester resin is a value determined by DSC (differential scanning calorimetry). The number average molecular weight of a noncrystalline polyester resin is a number average molecular weight in terms of polystyrene obtained using GPC (gel permeation chromatograph).

The content of the noncrystalline polyester resin in the photoreactive adhesive composition is preferably from 16.7 to 150 parts by weight, and more preferably from 16.7 to 75 parts by weight per 100 parts by weight of the monofunctional radically-polymerizable substance. The reason for this is that if the amount of the noncrystalline polyester resin is less than 16.7 parts by weight, the adhesiveness of the photoreactive adhesive composition may be deteriorated, and if the amount of the noncrystalline polyester resin is more than 150 parts by weight, the viscosity of the photoreactive adhesive composition may become high.

The photoradical polymerization initiator is a material which is activated by irradiation with light having a wavelength within the range of from 200 to 800 nm to promote the polymerization of a monofunctional radically-polymerizable substance. Examples of such photoradical polymerization initiators include 2-benzyl-2-dimethylamino-1-(4-morpholinophenyl)-butanone-1,2,4,6-(trimethylbenzoyl)diphenylphosphine oxide, bis(2,6-dimethoxybenzoyl)-2,4,4-trimethylpentylphosphine oxide, bis(cyclopentadienyl)-bis(2,6-difluoro-3-(pyrr-1-yl)titanium, 2,2-dimethoxy-1,2-diphenylethan-1-one, 1-hydroxy-cyclohexyl-phenyl-ketone, 2-methyl-1-[4-(methylthio)phenyl]-2-morpholinopropan-1-one; acetophenone-based substances such as 4-(2-hydroxyethoxy)phenyl(2-hydroxy-2-propyl)ketone, α-hydroxy-α,α′-dimethyl-acetophenone, methoxyacetophenone and 2,2-dimethoxy-2-phenylacetophenone; benzoin ether-based substances such as benzoin ethyl ether and benzoin isopropyl ether; ketal-based substances such as benzyl dimethyl ketal; halogenated ketones; acylphosphinoxides; acylphosphonates; and bis(2,6-dimethoxybenzoyl)-2,4,4-trimethylpentylphosphine oxide.

α-Hydroxy-α,α′-dimethyl-acetophenone is in the market, for example, under the commercial name “Dalocure 1173” from Ciba Specialty Chemicals. 4-(2-Hydroxyethoxy)phenyl(2-hydroxy-2-propyl)ketone is in the market, for example, under the commercial name “Dalocure 2959” from Ciba Specialty Chemicals. 2,2-Dimethoxy-1,2-diphenylethan-1-one is in the market, for example, under the commercial name “Irgacure 651” from Ciba Specialty Chemicals. 1-Hydroxy-cyclohexyl-phenyl-ketone is in the market, for example, under the name “Irgacure 184” from Ciba Specialty Chemicals. 2-Methyl-1-[4-(methylthio)phenyl]-2-morpholinopropan-1-one is in the market, for example, under the commercial name “Irgacure 907” from Ciba specialty Chemicals.

The content of the photoradical polymerization initiator in the photoreactive adhesive composition is preferably from 0.17 to 12.5 parts by weight per 100 parts by weight of the monofunctional radically-polymerizable substance. The reason for this is that if the photoradical polymerization initiator is present in an amount less than 0.17 parts by weight, the curability of the photoreactive adhesive composition may deteriorate, and if the photoradical polymerization initiator is present in an amount more than 12.5 parts by weight, the adhesiveness of the photoreactive adhesive composition may deteriorate.

The photocationic polymerization initiator is a catalyst which generates a cation species with the aid of light and promotes polymerization of a polyfunctional cationically-polymerizable substance. Examples of such a photocationic polymerization initiator include onium salts such as diazonium salts, e.g. phenyldiazonium salt of boron tetrafluoride, sulfonium salts, e.g. tri-4-methylphenyl sulfonium salt of arsenic hexafluoride and tri-4-methylphenyl sulfonium salt of antimony tetrafluoride, and iodonium salts, e.g. diphenyliodonium salt of phosphorus hexafluoride and diphenyliodonium salt of antimony hexafluoride; iron-arene complexes such as a ferrocene derivative, and arylsilanol-aluminium complexes.

Examples of commercially available products of such photocationic polymerization initiators include “Irgacure 261” produced by Ciba Specialty Chemicals, “Optomer SP-150,” “Optomer SP-151,” “Optomer SP-170,” and “Optomer SP-171” produced by Asahi Denka Co., Ltd., “UVE-1014” produced by General Electric Company, “CD-1012” produced by Sartomer Company, Inc., “San-Aid SI-60L,” “San-Aid SI-80L,” and “San-Aid SI-100L” produced by Sanshin Chemical Industry Co., Ltd., “CI-2064,” “CI-2639,” “CI-2624” and “CI-2481” produced by Nippon Soda Co., Ltd., “RHODORSIL PHOTOINITIATOR 2074” produced by Rhone-Poulenc S. A., “UVI-6992” produced by Union Carbide Corporation, and “BBI-103,” “MPI-103,” “TPS-103,” “MDS-103,” “DTS-103,” “NAT-103” and “NDS-103” produced by Midori Kagaku Co., Ltd. “Optomer SP-170” produced by Asahi Denka Co., Ltd. and “UVI-6992” produced by Union Carbide Corporation are preferred.

The content of the photocationic polymerization initiator in the photoreactive adhesive composition is preferably from 0.17 to 12.5 parts by weight, more preferably from 1.0 to 10.0 parts by weight per 100 parts by weight of the monofunctional radically-polymerizable substance. The reason for this is that if the photocationic polymerization initiator is present in an amount less than 0.17 parts by weight, the curability of the photoreactive adhesive composition may deteriorate, leading to increase in the percentage of water absorption, and if the photocationic polymerization initiator is present in an amount more than 12.5 parts by weight, the adhesiveness of the photoreactive adhesive composition may deteriorate.

The photoreactive adhesive composition of the present invention is preferably capable of being cured by UV light with an intensity of from 500 to 5000 mJ/cm² and the cured product has an elastic modulus at 25° C. of from 1×10⁷ to 2×10⁹ Pa, a glass transition temperature of from 10 to 60° C., and a percentage of water absorption of from 0.5 to 2.5%. The reason for this is that if the elastic modulus at 25° C. of the cured product of a photoreactive adhesive composition is less than 1×10⁷ Pa, the percentage of water absorption of the cured product of the photoreactive adhesive composition may become high; if the elastic modulus at 25° C. of the cured product of a photoreactive adhesive composition exceeds 2×10⁹ Pa, the cured product may break easily. If the glass transition temperature of the cured product of a photoreactive adhesive composition is lower than 10° C., the percentage of water absorption of the cured product of the photoreactive adhesive composition may become high. On the other hand, if the glass transition temperature of the cured product of a photoreactive adhesive composition exceeds 60° C., the flexibility of the cured product of the photoreactive adhesive composition will be lost and the cured product may break easily.

The elastic modulus of the cured product of a photoreactive adhesive composition is a value obtained by curing the photoreactive adhesive composition so as to have a thickness of 100 μm by application of UV light of from 500 to 5000 mJ/cm², and subjecting the resulting cured product to dynamic viscoelasticity measurement. Specifically, it can be determined by curing a photoreactive adhesive composition so as to have a thickness of 100 μm by application of UV light of from 500 to 5000 mJ/cm², and measuring the elastic modulus of the resulting cured product using a dynamic viscoelasticity measuring device (commercial name “DVA-200” produced by IT KeisokuSeigyoCo., Ltd.) underconditions: 23° C., shearingmode, a frequency of 10 Hz.

The glass transition temperature of the cured product of a photoreactive adhesive composition is a value determined by DSC (differential scanning calorimetry). Specifically, a photoreactive adhesive composition is cured by application of UV light of from 500 to 5000 mJ/cm² so as to have a thickness of 100 μm, and the elastic modulus of the resulting cured product is measured using a dynamic viscoelasticity measuring device (commercial name “DVA-200” produced by IT Keisoku Seigyo Co., Ltd.) under conditions: 23° C., tensile mode, and a frequency of 10 Hz. A glass transition temperature can be obtained by calculating a Tonset (according to TR K0005) from the elastic modulus.

The percentage of water absorption of the cured product of a photoreactive adhesive composition is determined in the following way. First, the photoreactive adhesive composition is cured by application of UV light of from 500 to 5000 mJ/cm² so as to have a thickness of 100 μm and the weight W₁ of the resulting cured product is measured. Next, the weight W₂ of the cured product after its immersion in water at 23° C. for 24 hours is measured. The percentage of water absorption can be calculated based on the following equation:

Percentage of water absorption (%)=100×(W₂−W₁)/W₁.

Unless the object of the present invention is hindered, conventional sensitizers, polymerization inhibitors, antioxidants, UV absorbers, light stabilizers, defoaming agents, leveling agents, pigments, tackifying resins, viscosity modifiers, and the like may, if necessary, be incorporated in the photoreactive adhesive composition of the present invention.

The tackifying resin may be, for example, but is not limited to, a rosin-based resin, a modified rosin-based resin, a terpene-based resin, a terpene phenol-based resin, an aromatic modified terpene-based resin, a C5 or C9 petroleum resin, or a coumarone resin.

The viscosity modifier is incorporated in order to improve the coatability. Examples thereof include thickeners such as acrylic rubber, epichlorohydrin rubber, isoprene rubber and butyl rubber; thixotropic agents such as colloidal silica and polyvinyl pyrrolidone; extenders such as clay; and conditioners such as acrylic polymer, polyester, polyurethane, silicone, polyvinyl ether, polyvinyl chloride, polyvinyl acetate, polyisobutylene and wax.

In the present invention, photocationic polymerization and photoradical polymerizationare used together. Therefore, in order to control deactivation of active species by oxygen concentration, moisture, amine compounds and alkali compounds, attention should be paid to avoid the contamination of such components into the system.

The photoreactive adhesive composition of the present invention is preferably sensitive to light containing a component having a wavelength of from 300 to 800 nm. If a photoreactive adhesive composition is sensitive to light containing only a component having a wavelength less than 300 nm, when the photoreactive adhesive composition is applied thickly, a skin is easily formed on the surface exposed to light and the composition may fail to cure uniformly from the surface layer through the deep portion. On the other hand, if a photoreactive adhesive composition is sensitive to light containing only a component having a wavelength greater than 800 nm, it may become difficult to provide a sufficient amount of light energy and the curing speed may become slow while a skin is hardly formed and the composition cures uniformly to its deep portion. In order to cure a photoreactive adhesive composition to its internal portion by preventing it from curing only in its surface layer, the light irradiation may be carried out by cutting off light of 300 nm or less.

As a light source lamp used for the light irradiation, lamps which can emit light containing a component having a wavelength of from 300 to 800 nm are preferred. Examples of such a light source lamp include a low-pressure mercury lamp, a medium-pressure mercury lamp, a high-pressure mercury lamp, an ultrahigh-pressure mercury lamp, a chemical lamp, a black light lamp, a microwave-excited mercury lamp, a metal halide lamp, a sodium lamp and a fluorescent lamp. Natural light like sunlight may be used for light irradiation.

The photoreactive adhesive composition of the present invention preferably has a viscosity of from 10000 to 100000 mPa·s at a temperature of from 10 to 40° C. If the viscosity is less than 10000 mPa·s at a temperature of from 10 to 40° C., the fluidity of the photoreactive adhesive composition may be too high. If the fluidity of a photoreactive adhesive composition is too high, the photoreactive adhesive composition easily flows to an area which should not be coated and therefore it may have poor workability, and when the photoreactive adhesive composition is used for sealing of a liquid crystal, the liquid crystal may be polluted easily. On the other hand, if the viscosity is higher than 100000 mPa·s at a temperature of from 10 to 40° C., the fluidity of the photoreactive adhesive composition may be too low and it may be difficult to apply the composition.

The photoreactive adhesive composition of the present invention can be used as a sealing material of a liquid crystal in the production of liquid crystal panels. As shown in FIG. 1, a liquid crystal panel 1 is composed of base materials 2, 3 arranged parallel to each other at a predetermined distance, a cured product 4 of a photoreactive adhesive composition having been arranged in a frame shape on outer peripheral parts of facing surfaces of the base materials 2, 3 and joining these base materials, and a liquid crystal 5 filled in a liquid crystal filling space surrounded by the base materials 2, 3 and the cured product 4 of the photoreactive adhesive composition.

As the base materials 2, 3 of the liquid crystal panel, for example, a synthetic resin film having been subjected to electroconductive treatment such as ITO (indium tin oxide) treatment is used.

As such a synthetic resin film, a product having an elastic modulus of from 490 to 2940 Pa and an elongation at break of from 50 to 500% is preferred. The reason for this is that if the synthetic resin film has an elastic modulus less than 490 Pa, it will become difficult to maintain the shape of the synthetic resin film, and if the synthetic resin film has an elastic modulus greater than 2940 Pa, the synthetic resin film will lose flexibility and as a result it may be easily broken.

The reason for this is that if the synthetic resin film has an elongation at break less than 50%, the synthetic resin film will deteriorate in flexibility and as a result it may be easily broken, and if the synthetic resin film has an elongation at break greater than 500%, it may become difficult to maintain the shape of the synthetic resin film.

The elastic modulus of a synthetic resin film means a value determined by using a specimen in a dumbbell No. 3 shape in accordance with JIS K6251. The elongation at break of a synthetic resin film means a value determined by using a specimen in a dumbbell No. 3 shape in accordance with JIS K6251. Specifically, the elastic modulus and elongation at break of a synthetic resin film can be measured at a tensile speed of 50 mm/min by use of a specimen having a dumbbell No. 3 shape using a tensile tester (commercial name “Instron 4469” produced by Instron) as a measuring instrument. In the measurement of the elongation at break, the elongation/gauge length at the time of breaking is adjusted to 20 mm.

The liquid crystal panel can be produced in the following way. First, a photoreactive adhesive composition is applied in a frame shape to the outer peripheral part, except a liquid crystal injection inlet area, of a base material 2 among two base materials 2, 3. The method of applying the photoreactive adhesive composition is not particularly restricted and may be, for example, spin coating, dip coating, gravure coating, methods using a roll coater, a comma coater, a symsizer or a sizepress, screen printing, or the like.

The temperature at which the photoreactive adhesive composition is applied to the surface of a base material is appropriately chosen depending on the base material and the coating method, and is preferably from 15 to 80° C.

The other base material 3 is put on the photoreactive adhesive composition-coated surface of the base material 2, so that the two base materials 2, 3 are joined by the frame-shaped photoreactive adhesive composition. Thereafter, light is applied to the photoreactive adhesive composition through the base materials to polymerize and cure the composition. The quantity of light applied to a photoreactive adhesive composition, which may be adjusted appropriately, is preferably from 500 to 5000 mJ/cm², and more preferably from 500 to 3000 mJ/cm².

A liquid crystal panel 1 shown in FIG. 1 can be obtained by injecting a liquid crystal through a liquid crystal injection inlet into a liquid crystal filling space formed by the two base materials 2, 3 and the cured product 4 of the photoreactive adhesive composition which has been arranged in a frame shape between the outer peripheral parts of the facing surfaces of the base materials 2, 3 and which has joined the base materials 2, 3 together, and then closing the liquid crystal injection inlet.

The photoreactive adhesive composition of the present invention is cured in a short time and has a low percentage of water absorption and excellent adhesiveness after curing because it contains a monofunctional radically-polymerizable substance, a polyfunctional cationically-polymerizable substance, a noncrystalline polyester resin, a photoradical polymerization initiator, and a photocationic polymerization initiator.

The photoreactive adhesive composition exhibits even better adhesiveness after curing when the monofunctional radically-polymerizable substance includes a monofunctional (meth)acryl-based monomer and/or a monofunctional (meth)acryl-based oligomer.

When the photoreactive adhesive composition is cured by UV light with an intensity of from 500 to 5000 mJ/cm² and the cured product has an elastic modulus at 25° C. of from 1×10⁷ to 2×10⁹ Pa, a glass transition temperature of from 10 to 60° C., and a percentage of water absorption of from 0.5 to 2.5%, the photoreactive adhesive composition exhibits a even higher percentage of water absorption and further improved adhesiveness after curing and has further enhanced flexibility after curing.

Furthermore, when the photoreactive adhesive composition contains the polyfunctional cationically-polymerizable substance, the noncrystalline polyester resin, the photoradical polymerization initiator and the photocationic polymerization initiator in amounts of from 15 to 75 parts by weight, from 16.7 to 150 parts by weight, from 0.17 to 12.5 parts by weight, and from 0.17 to 12.5 parts by weight, respectively, per 100 parts by weight of the monofunctional radically-polymerizable substance, the composition cures certainly in a short time and exhibits a more reduced percentage of water absorption and more improved adhesiveness after curing.

The liquid crystal panel of the present invention is composed of base materials that are made of a synthetic resin film having an elastic modulus of from 490 to 2940 Pa and an elongation at break of from 50 to 500% and are arranged at a predetermined distance away from each other; a cured product of a photoreactive adhesive composition arranged in a frame shape on the outer peripheral parts of the facing surfaces of the base materials; and a liquid crystal filled in a liquid crystal filling space surrounded by the base materials and the cured product of the photoreactive adhesive composition. Therefore, it can improve the adhesiveness between the base materials and can prevent pollution of the liquid crystal. Thereby, the quality of display of a liquid crystal display device obtained can be improved. Furthermore, the liquid crystal panel can be used in a wide variety of applications because it is excellent also in flexibility.

### EXAMPLES

The present invention is described in more detail below with reference to Examples. However, the present invention is not limited to the Examples.

### Examples 1-9

2-Hydroxy-3-phenoxypropyl acrylate (commercial name “Epoxy Ester M-600A” produced by Kyoeisha Chemical Co., Ltd.) as a monofunctional radically-polymerizable substance, completely hydrogenated bifunctional bisphenol A diglycidyl ether (commercial name “ADEKA RESIN EP-4080” produced by Adeka Corporation) as a polyfunctional cationically-polymerizable substance, a polyester resin having a glass transition temperature of 4° C. and a number average molecular weight of 23000 (commercial name “Vylon 500” produced by Toyobo Co., Ltd.) as a noncrystalline polyester resin, and a photoradical polymerization initiator (commercial name “Irgacure 651” produced by Ciba Specialty Chemicals) in predetermined amounts shown in Table 1 or 2 were fed into an about 200-ml sample tube, and then heated and mixed at 150° C. After cooling to 80° C., a photocationic polymerization initiator (commercial name “UVI-6992” produced by Union Carbide Corporation) in a predetermined amount shown in Table 1 or 2 was added and mixed. Thus, a photoreactive adhesive composition was obtained.

### Example 10

A photoreactive adhesive composition was obtained in the same manner as in Example 1 except using a polyester resin (commercial name “Vylon GK780” produced by Toyobo Co., Ltd.) having a glass transition temperature of 36° C. and a number average molecular weight of 11000 as a noncrystalline polyester resin.

### Example 11

A photoreactive adhesive composition was obtained in the same manner as in Example 1 except using a polyester resin (commercial name “Vylon GK680” produced by Toyobo Co., Ltd.) having a glass transition temperature of 10° C. and a number average molecular weight of 6000 as a noncrystalline polyester resin.

### Example 12

A photoreactive adhesive composition was obtained in the same manner as in Example 1 except using a polyester resin (commercial name “Vylon 560” produced by Toyobo Co., Ltd.) having a glass transition temperature of 7° C. and a number average molecular weight of 19000 as a noncrystalline polyester resin.

### Examples 13-16

2-Hydroxy-3-phenoxypropyl acrylate (commercial name “Epoxy Ester M-600A” produced by Kyoeisha Chemical Co., Ltd.) as a monofunctional radically-polymerizable substance, 1,6-hexanediol diacrylate (produced by Kyoeisha Chemical Co., Ltd.), which is a bifunctional acryl-based monomer, completely hydrogenated bifunctional bisphenol A diglycidyl ether (commercial name “ADEKA RESIN EP-4080” produced by Adeka Corporation) as a polyfunctional cationically-polymerizable substance, a polyester resin having a glass transition temperature of 4° C. and a number average molecular weight of 23000 (commercial name “Vylon 500” produced by Toyobo Co., Ltd.) as a noncrystalline polyester resin, and a photoradical polymerization initiator (commercial name “Irgacure 651” produced by Ciba Specialty Chemicals) in predetermined amounts shown in Table 4 were fed into an about 200-ml sample tube, and then heated and mixed at 150° C. After cooling to 80° C., a photocationic polymerization initiator (commercial name “UVI-6992” produced by Union Carbide Corporation) in a predetermined amount shown in Table 4 was added and mixed. Thus, a photoreactive adhesive composition was obtained.

### Example 17

A photoreactive adhesive composition was obtained in the same manner as in Example 1 except using a phenoxypolyethylene glycol acrylate (commercial name “NK ESTER AMP-60G” produced by Shin-nakamura Chemical Corporation) as a monofunctional radically-polymerizable substance.

### Comparative Example 1

A photoreactive adhesive composition was obtained by feeding 100 parts by weight of 1,6-hexanediol diacrylate (produced by Kyoeisha Chemical Co., Ltd.) as a bifunctional acryl-based monomer, 40 parts by weight of completely -hydrogenated-bifunctional-bisphenol-A-diglycidyl ether (commercial name “ADEKA RESIN EP-4080” produced by Adeka Corporation) as a polyfunctional cationically-polymerizable substance, 2 parts by weight of a photoradical polymerization initiator (Irgacure 651 produced by Ciba Specialty Chemicals) and 3 parts by weight of a photocationic polymerization initiator (commercial name “UVI-6992” produced by Union Carbide Corporation) into an about 200-ml sample tube, followed by mixing and melting at 60° C.

### Comparative Example 2

A photoreactive adhesive composition was obtained by feeding 100 parts by weight of 2-hydroxy-3-phenoxypropyl acrylate (commercial name “EPOXY ESTER M600-A” produced by Kyoeisha Chemical Co., Ltd.), 60 parts by weight of a polyester resin (commercial name “Vylon 500” produced by Toyobo Co., Ltd.) having a glass transition temperature of 4° C. and a number average molecular weight of 23000 as a noncrystalline polyester resin, and 2 parts by weight of a photoradical polymerization initiator (commercial name “Irgacure 651” produced by Ciba Specialty Chemicals) into an about 200-ml sample tube, followed by heating and mixing at 150° C.

### Comparative Example 3

100 parts by weight of completely hydrogenated bifunctional bisphenol A diglycidyl ether (commercial name “ADEKA RESIN EP-4080” produced by Adeka Corporation) as a polyfunctional cationically-polymerizable substance, and 60 parts by weight of a polyester resin (commercial name “Vylon 500” produced by Toyobo Co., Ltd.) having a glass transition temperature of 4° C. and a number average molecular weight of 23000 as a noncrystalline polyester resin were added into an about 200-ml sample tube and mixed at 150° C. After cooling to 80° C., 4 parts by weight of a photocationic polymerization initiator (commercial name “UVI-6992” produced by Union Carbide Corporation) was added and mixed. Thus, a photoreactive adhesive composition was obtained.

A cured product of the resulting photoreactive adhesive composition was measured for its elastic modulus at 25° C., glass transition temperature and percentage of water absorption in the ways mentioned above. The peel strength and curability of the photoreactive adhesive composition obtained were measured in the ways shown below. The measurement results are shown in Tables 1 to 6. In Tables 1 to 6, the “elastic modulus of the cured product of a photoreactive adhesive composition at 25° C.” is expressed by “elastic modulus at 25° C.”

(Peel Strength)

Two polyethylene terephthalate films (elastic modulus: 1891 Pa (193 kgf/cm²), elongation at break: 175%) with a thickness of 130 μm which had been subjected to ITO electroconductive treatment were prepared. The photoreactive adhesive composition obtained in an Example or a Comparative Example was applied in a thickness of about 50 μm to one of the polyethylene terephthalate films. The other polyethylene terephthalate film was then put on the photoreactive adhesive composition, so that the photoreactive adhesive composition was sandwiched by the pair of polyethylene terephthalate films.

Then, UV light having a wavelength of 365 nm and an intensity of 1500 mJ/cm² was applied to the photoreactive adhesive composition through the polyethylene terephthalate films and thereby the photoreactive adhesive composition was polymerized and cured.

Subsequently, the 180° peel strength at the time of peeling one of the polyethylene terephthalate films was measured at a speed of 50 mm/min using a tensile tester.

(Curability)

A photoreactive adhesive composition was irradiated with UV light in the same way as that used in the peel strength measurement, and immediately after the irradiation, one of the polyethylene terephthalate films was peeled and judgment was made according to the following criteria.

Good: Cured (no tackiness-slight tackiness)

Poor: Not cured (liquid-strong tackiness)

TABLE 1

| | | | Example 1 | Example 2 | Example 3 | Example 4 | Example 5 |
|---|---|---|---|---|---|---|---|
| Photoreactive | Monofunctional | M-600A | 100 | 100 | 100 | 100 | 100 |
| adhesive composition | radically-polymerizable | | | | | | |
| (parts by weight) | substance | | | | | | |
| | Polyfunctional | ADEKA RESIN | 40 | 15 | 80 | 40 | 40 |
| | cationically- | EP-4080 | | | | | |
| | polymerizable substance | | | | | | |
| | Noncrystalline polyester | Vylon 500 | 60 | 60 | 60 | 15 | 150 |
| | resin | | | | | | |
| | Photoradical | Irgacure 651 | 3 | 3 | 3 | 3 | 3 |
| | polymerization initiator | | | | | | |
| | Photocationic | UVI-6992 | 4 | 2 | 8 | 4 | 4 |
| | polymerization initiator | | | | | | |

| | | | | | | |
|---|---|---|---|---|---|---|
| Results of | Elastic modulus at 25° C. (Pa) | 0.4 × 10⁹ | 0.5 × 10⁹ | 5.0 × 10⁹ | 2.0 × 10⁹ | 0.9 × 10⁹ |
| measurement | Glass transition temperature (° C.) | 42 | 30 | 60 | 90 | 30 |
| | Percentage of water absorption (%) | 2.1 | 2.5 | 1.5 | 1.5 | 2 |
| | Peel strength (N/25 mm) | 22.2 | 28 | 5 | 5 | 22 |
| | Curability | Good | Good | Good | Good | Good |

TABLE 2

| | | | Example 6 | Example 7 | Example 8 | Example 9 |
|---|---|---|---|---|---|---|
| Photoreactive | Monofunctional radically- | M-600A | 100 | 100 | 100 | 100 |
| adhesive composition | polymerizable substance | | | | | |
| (parts by weight) | Polyfunctional | ADEKA RESIN | 20 | 60 | 50 | 50 |
| | cationically- | EP-4080 | | | | |
| | polymerizable substance | | | | | |
| | Noncrystalline polyester | Vylon 500 | 50 | 50 | 20 | 60 |
| | resin | | | | | |
| | Photoradical | Irgacure 651 | 3 | 3 | 3 | 3 |
| | polymerization initiator | | | | | |
| | Photocationic | UVI-6992 | 2 | 6 | 4 | 4 |
| | polymerization initiator | | | | | |

| | | | | | |
|---|---|---|---|---|---|
| Results of | Elastic modulus at 25° C. (Pa) | 0.9 × 10⁹ | 1.0 × 10⁹ | 2.0 × 10⁹ | 0.5 × 10⁹ |
| measurement | Glass transition temperature (° C.) | 40 | 40 | 88 | 40 |
| | Percentage of water absorption (%) | 2.2 | 1.8 | 1.9 | 1.8 |
| | Peel strength (N/25 mm) | 22 | 10 | 5 | 10 |
| | Curability | Good | Good | Good | Good |

TABLE 3

| | | | Example 10 | Example 11 | Example 12 |
|---|---|---|---|---|---|
| Photoreactive adhesive | Monofunctional radically- | M-600A | 100 | 100 | 100 |
| composition (parts by | polymerizable substance | | | | |
| weight) | Polyfunctional | ADEKA RESIN | 40 | 40 | 40 |
| | cationically-polymerizable | EP-4080 | | | |
| | substance | | | | |
| | Noncrystalline polyester | Vylon GK780 | 60 | — | — |
| | resin | Vylon GK680 | — | 60 | — |
| | | Vylon GK560 | — | — | 60 |
| | Photoradical polymerization | Irgacure 651 | 3 | 3 | 3 |
| | initiator | | | | |
| | Photocationic | UVI-6992 | 4 | 4 | 4 |
| | polymerization initiator | | | | |

| | | | | |
|---|---|---|---|---|
| Results of | Elastic modulus at 25° C. (Pa) | 1.0 × 10⁹ | 0.5 × 10⁹ | 0.4 × 10⁹ |
| measurement | Glass transition temperature (° C.) | 50 | 40 | 44 |
| | Percentage of water absorption (%) | 2 | 2 | 2.1 |
| | Peel strength (N/25 mm) | 15 | 22 | 25 |
| | Curability | Good | Good | Good |

TABLE 4

| | | | Example 13 | Example 14 | Example 15 | Example 16 |
|---|---|---|---|---|---|---|
| Photoreactive | Monofunctional | M-600A | 100 | 100 | 100 | 100 |
| adhesive composition | radically-polymerizable | | | | | |
| (parts by weight) | substance | | | | | |
| | Polyfunctional | ADEKA RESIN EP- | 40 | 40 | 40 | 40 |
| | cationically- | 4080 | | | | |
| | polymerizable substance | | | | | |
| | Noncrystalline polyester | Vylon 500 | 60 | 60 | 60 | 60 |
| | resin | | | | | |
| | Photoradical | Irgacure 651 | 3 | 3 | 3 | 3 |
| | polymerization initiator | | | | | |
| | Photocationic | UVI-6992 | 4 | 4 | 4 | 4 |
| | polymerization initiator | | | | | |
| | Bifunctional acryl-based | 1,6-Hexanediol | 5 | 10 | 15 | 30 |
| | monomer | diacrylate | | | | |

| | | | | | |
|---|---|---|---|---|---|
| Results of | Elastic modulus at 25° C. (Pa) | 1.0 × 10⁹ | 1.0 × 10⁹ | 2.0 × 10⁹ | 1.0 × 10⁹ |
| measurement | Glass transition temperature (° C.) | 42 | 44 | 46 | 49 |
| | Percentage of water absorption (%) | 2 | 1.5 | 1.5 | 1.2 |
| | Peel strength (N/25 mm) | 22 | 20 | 15 | 5 |
| | Curability | Good | Good | Good | Good |

TABLE 5

| | | | Example 17 |
|---|---|---|---|
| Photoreactive | Monofunctional radically- | NK ESTER AMP- | 100 |
| adhesive composition | polymerizable substance | 60G | |
| (parts by weight) | Polyfunctional | ADEKA RESIN | 40 |
| | cationically-polymerizable | EP-4080 | |
| | substance | | |
| | Noncrystalline polyester | Vylon 500 | 60 |
| | resin | | |
| | Photoradical | Irgacure 651 | 3 |
| | polymerization initiator | | |
| | Photocationic | UVI-6992 | 4 |
| | polymerization initiator | | |

| | | |
|---|---|---|
| Results of | Elastic modulus at 25° C. (Pa) | 0.4 × 10⁹ |
| measurement | Glass transition temperature (° C.) | 35 |
| | Percentage of water absorption (%) | 2.2 |
| | Peel strength (N/25 mm) | 23.2 |
| | Curability | Good |

TABLE 6

| | | | Comparative | Comparative | Comparative |
|---|---|---|---|---|---|
| | | | Example 1 | Example 2 | Example 3 |
| Photoreactive | Monofunctional | M-600A | — | 100 | — |
| adhesive composition | radically-polymerizable | | | | |
| (parts by weight) | substance | | | | |
| | Polyfunctional | ADEKA RESIN | 40 | — | 100 |
| | cationically- | EP-4080 | | | |
| | polymerizable substance | | | | |
| | Noncrystalline polyester | Vylon 500 | — | 60 | 60 |
| | resin | | | | |
| | Photoradical | Irgacure 651 | 2 | 2 | — |
| | polymerization initiator | | | | |
| | Photocationic | UVI-6992 | 3 | — | 4 |
| | polymerization initiator | | | | |
| | Bifunctional acryl-based | 1,6- | 100 | — | — |
| | monomer | Hexanediol | | | |
| | | diacrylate | | | |

| | | | | |
|---|---|---|---|---|
| Results of | Elastic modulus at 25° C. (Pa) | 2.0 × 10⁹ | 3.0 × 10⁷ | — |
| measurement | Glass transition temperature (° C.) | 90 | 27 | — |
| | Percentage of water absorption (%) | 0.8 | 3.8 | 1 |
| | Peel strength (N/25 mm) | 4.5 | 50.6 | 4.7 |
| | Curability | Good | Good | Poor |

As shown in Table 1, the photoreactive adhesive composition of Example 1 had high adhesiveness and a low percentage of water absorption, and exhibited sufficient curability even immediately after the UV irradiation.

On the other hand, in the photoreactive adhesive composition of Comparative Example 1, since it contained no noncrystalline polyester resin, the composition was poor in adhesiveness though it had a high crosslink density and a low percentage of water absorption. In the photoreactive adhesive composition of Comparative Example 2, since it contained no polyfunctional cationically-polymerizable substance, adhesiveness was developed to some extent, but the percentage of water absorption was high. In the photoreactive adhesive composition of Comparative Example 3, since it contained only a polyfunctional cationically-polymerizable substance, the composition was poor in adhesiveness though it had a high crosslink density and a low percentage of water absorption.

What is claimed is:

1. A photoreactive adhesive composition comprising a monofunctional radically-polymerizable substance, a polyfunctional cationically-polymerizable substance, a noncrystalline polyester resin, a photoradical polymerization initiator and a photocationic polymerization initiator.

2. The photoreactive adhesive composition according to claim 1, wherein the monofunctional radically-polymerizable substance comprises a monofunctional (meth)acryl-based monomer and/or a monofunctional (meth)acryl-based oligomer.

3. The photoreactive adhesive composition according to claim 1, wherein the composition is cured by UV light with an intensity of from 500 to 5000 mJ/cm² and the cured product has an elastic modulus at 25° C. of from 1×10⁷ to 2×10⁹ Pa, a glass transition temperature of from 10 to 60° C., and a percentage of water absorption of from 0.5 to 2.5%.

4. The photoreactive adhesive composition according to claim 1, wherein the composition contains the polyfunctional cationically-polymerizable substance, the noncrystalline polyester resin, the photoradical polymerization initiator and the photocationic polymerization initiator in amounts of from 15 to 75 parts by weight, from 16.7 to 150 parts by weight, from 0.17 to 12.5 parts by weight, and from 0.17 to 12.5 parts by weight, respectively, per 100 parts by weight of the monofunctional radically-polymerizable substance.

5. The photoreactive adhesive composition according to claim 1, wherein the polyfunctional cationically-polymerizable substance is a polyfunctional glycidyl ether compound.

6. The photoreactive adhesive composition according to claim 1, wherein the noncrystalline polyester resin has a glass transition temperature of 20° C. or lower and a number average molecular weight of from 5000 to 100000.

7. A liquid crystal panel comprising two base materials that are made of a synthetic resin film having an elastic modulus of from 490 to 2940 Pa and an elongation at break of from 50 to 500% and are arranged at a predetermined distance away from each other; a cured product that is prepared by curing a photoreactive adhesive composition comprising a monofunctional radically-polymerizable substance, a polyfunctional cationically-polymerizable substance, a noncrystalline polyester resin, a photoradical polymerization initiator and a photocationic polymerization initiator, the cured product being arranged in a frame shape on outer
